(19) United States
(12) Patent Application Publication
(10) Pub. No.: US 2015/0194838 A1
(43) Pub. Date: Jul. 9, 2015

(54) METHOD FOR WIRELESSLY CHARGING MULTI-NODE WIRELESS POWER TRANSMITTING SYSTEM

(71) Applicant: INTELLECTUAL DISCOVERY CO., LTD., Seoul (KR)

(72) Inventors: Yun Jae Won, Yongin-si (KR); Seung Ok Lim, Seongnam-si (KR)

(73) Assignee: INTELLECTUAL DISCOVERY CO., LTD., Seoul (KR)

(21) Appl. No.: 14/414,949

(22) PCT Filed: Jul. 31, 2013
(86) PCT No.: PCT/KR2013/006860

§ 371 Date: Jan. 15, 2015

(30) Foreign Application Priority Data
Jul. 31, 2012 (KR) 10-2012-0084177
Jul. 31, 2012 (KR) 10-2012-0084179

(51) Int. Cl. H02J 7/02; H02J 7/00

(52) U.S. Cl. CPC H02J 7/025; H02J 7/0013; H02J 7/0052; H02J 7/007

(57) ABSTRACT

The present invention relates to a method for wirelessly charging a multi-node wireless power transmitting system which can efficiently perform charging using wireless communication. According to the method, a wireless power supply apparatus detects a change in a power transmission environment on the basis of a current/voltage change to accordingly perform rematching or reschedule, and combines and uses a power transmission method through time division for the simultaneous charging of a plurality of devices and a simultaneous power transmission method through multi-matching.

### TECHNICAL FIELD

The present invention relates to a wireless charging system and method, and more particularly, to a wireless charging method of a multi-node wireless power transmission system capable of efficient charging based on wireless communication.

### BACKGROUND ART

As a wireless power transmission technology for wirelessly transferring energy, a wireless charging system using a magnetic induction phenomenon is in use.

For example, an electric toothbrush, a cordless razor, etc. are charged according to the principle of electromagnetic induction. In recent years, wireless charging products capable of charging portable devices, such as a cellular phone, a personal digital assistant (PDA), a Moving Picture Experts Group (MPEG) audio layer 3 (MP3) player, and a laptop computer, using electromagnetic induction have been released.

However, a magnetic induction method of inducing current from one coil to another coil through a magnetic field is very sensitive to the distance between the coils and the relative positions thereof, and thus transmission efficiency is drastically reduced even when the distance between the two coils slightly increases or the two coils are slightly misaligned with each other. Therefore, a charging system using this magnetic induction method has a weakness that it can be used only in a short range of several centimeters or less.

Meanwhile, U.S. Pat. No. 7,741,735 discloses a non-radiative energy transfer method based on evanescent wave coupling in a resonant field. The basis of the method is that two resonant objects having the same frequency do not influence other nearby non-resonant objects but tend to be coupled to each other, and is introduced as a technology for transferring energy over a longer distance than existing electromagnetic induction.

### DISCLOSURE

### Technical Problem

The present invention is directed to providing a wireless charging method for a wireless power transmission system based on wireless communication to maintain an optimal power transmission environment.

The present invention is also directed to providing a wireless charging method for simultaneously charging a plurality of devices.

### Technical Solution

In order to solve the aforementioned problems, in the present invention, a wireless power supply apparatus in a wireless power transmission system based on wireless communication senses a change of a power transmission environment through a change of current/voltage to perform re-matching or rescheduling accordingly, and uses a power transmission method based on time division and a power transmission method based on multi-matching in combination to simultaneously charge a plurality of devices.

One aspect of the present invention provides a multi-node wireless charging method using magnetic field communication which is a method for a wireless power supply apparatus to charge a plurality of wirelessly chargeable devices in a multi-node wireless power transmission system including the wireless power supply apparatus and the wirelessly chargeable devices spaced apart from the wireless power supply apparatus and wirelessly communicating with the wireless power supply apparatus, the multi-node wireless charging method including: transmitting an association request frame; receiving association response frames from the wirelessly chargeable devices; transmitting a power transmission request frame; receiving charging request response frames from the wirelessly chargeable devices; transmitting wireless-charging schedule information for the wirelessly chargeable devices having transmitted the charging request response frames; and transmitting power to the wirelessly chargeable devices according to the wireless-charging schedule information. The transmitting of the power may include monitoring a change of a power transmission environment by measuring a voltage or a current of the wireless power supply apparatus.

The transmitting of the association request frame, the receiving of the association response frames, the transmitting of the power transmission request frame, the receiving of the charging request response frames, and the transmitting of the wireless-charging schedule information may be periodically repeated, and when the change of the power transmission environment is sensed, the transmitting of the association request frame, the receiving of the association response frames, the transmitting of the power transmission request frame, the receiving of the charging request response frames, and the transmitting of the wireless-charging schedule information may be performed again.

When the change of the power transmission environment is sensed, the wireless power supply apparatus may control a matching circuit in the wireless power supply apparatus to perform frequency matching.

The association response frame may include unique identifications (IDs) of the wirelessly chargeable devices, the multi-node wireless charging method may further include assigning dynamic IDs corresponding to the unique IDs of the wirelessly chargeable devices, and the power transmission request frame may be transmitted based on the dynamic IDs.

The charging request response frames may include battery information of the wirelessly chargeable devices and information on amounts of power desired to be received per hour, and the transmitting of the power may include simultaneously transmitting the power to two or more of the wirelessly chargeable devices.

Another aspect of the present invention provides a wireless power supply apparatus which wirelessly communicating with a plurality of wirelessly chargeable devices, supplies wireless power to the plurality of wirelessly chargeable devices, and includes: an oscillator configured to generate a signal of a predetermined uniform frequency; an amplifier configured to amplify the signal generated by the oscillator; a matching circuit configured to frequency match the signal amplified by the amplifier; a transmitting antenna configured to transmit the signal frequency-matched by the matching circuit to the wirelessly chargeable devices; a rectifier configured to convert an alternating current (AC) voltage applied through the matching circuit into a direct current (DC) voltage; a current/voltage checker connected to the rectifier and configured to check a change of a current and/or the voltage; and a communication signal processor connected to the matching circuit and configured to process a communication signal with the wirelessly chargeable devices.

Another aspect of the present invention provides a multi-node wireless charging method for a wireless power supply apparatus to charge a plurality of wirelessly chargeable devices in a multi-node wireless power transmission system including the wireless power supply apparatus and the wirelessly chargeable devices spaced apart from the wireless power supply apparatus and wirelessly communicating with the wireless power supply apparatus, the multi-node wireless charging method including: transmitting wireless power to the wirelessly chargeable devices during a power transmission period divided into two or more slots so as to transmit the wireless power using a time-division method. The wireless power is simultaneously transmitted to two or more of the wirelessly chargeable devices in one of the slots.

The slots may include: a charging period for simultaneously transmitting the wireless power to the two or more wirelessly chargeable devices; and a request period in which the wireless power supply apparatus transmits a power receiving state request to the wirelessly chargeable devices, and may further include, after the request period, two or more response periods for sequentially receiving response packets from the two or more wirelessly chargeable devices.

Lengths of the response periods may be fixed, and lengths of the charging period and the request period may be variable.

When the wireless power supply apparatus is infiltrated by a foreign substance or an error occurs, the wireless power supply apparatus may indicate the infiltration of the foreign substance or the occurrence of the error through the request period, and during the request period, all the wirelessly chargeable devices included in the multi-node wireless power transmission system may wake up and receive the power receiving state request.

In addition, the multi-node wireless charging method may further include, before the transmitting of the wireless power, transmitting wireless-charging schedule information for the wirelessly chargeable devices to the wirelessly chargeable devices.

### Advantageous Effects

According to the present invention, when there is a change of distances from wirelessly chargeable devices which receive power or a change of the number of wirelessly chargeable devices, the change of a power transmission environment is sensed, and accordingly a matching circuit is controlled or power transmission is rescheduled. Therefore, it is possible to maintain an optimal power transmission environment and actively cope with a variable power transmission environment.

In addition, when time-division power transmission is performed in a multi-node wireless power transmission system, power can be simultaneously transmitted to several nodes during one time slot, and thus efficient simultaneous charging is possible.

### DESCRIPTION OF DRAWINGS

FIG. 1 is a block diagram schematically showing an overall constitution of a multi-node wireless charging system according to an embodiment of the present invention.

FIG. 2 is a diagram showing a structure of a superframe used in a multi-node wireless charging method according to an embodiment of the present invention.

FIG. 3 is a diagram showing a constitution of a wireless power supply apparatus of a multi-node wireless charging system according to an embodiment of the present invention.

FIG. 4 is a block diagram showing constitutions of a wireless power supply apparatus and a wirelessly chargeable device in a multi-node wireless charging system according to an embodiment of the present invention.

FIG. 5 is a diagram showing a structure of a superframe used in a multi-node wireless charging system according to an embodiment of the present invention.

FIG. 6 is a diagram showing a response period of a superframe according to an embodiment of the present invention.

FIG. 7 is a diagram showing a power transmission period of a superframe according to an embodiment of the present invention.

### MODES OF THE INVENTION

Advantages and features of the present invention and a method of achieving the same will be more clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims.

Meanwhile, terms used herein are provided only to describe specific embodiments and are not intended to restrict the present invention. As used herein, the singular forms are intended to include the plural forms as well, unless context clearly indicates otherwise. The terms “comprises” and/or “comprising” used herein designate stated components, steps, operations, and/or elements, but do not exclude presence or addition of one or more other components, steps, operations, and/or elements.

Hereinafter, a multi-node wireless charging system according to an embodiment of the present invention will be described in detail with reference to the accompanying drawings.

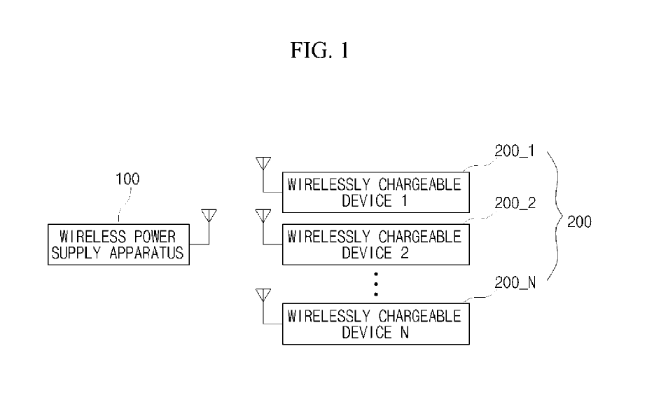

FIG. 1 is a block diagram schematically showing an overall constitution of a multi-node wireless charging system according to an embodiment of the present invention.

As shown in FIG. 1, a multi-node wireless charging system according to an embodiment of the present invention includes a wireless power supply apparatus 100 which wirelessly supplies power and a plurality of wirelessly chargeable devices 200_1, 200_2, . . . , and 200_N which are a predetermined distance apart from the wireless power supply apparatus 100 and wirelessly supplied with power from the wireless power supply apparatus 100.

In a multi-node wireless charging system according to an embodiment of the present invention, the wireless power supply apparatus 100 may supply wireless power to the wirelessly chargeable devices 200 using a magnetic resonance method. With the magnetic resonance method, efficiency in the wireless transmission of energy is maximized by resonance between a transmitting antenna and a receiving antenna. To this end, a resonance channel is formed by matching a resonant frequency between the wireless power supply apparatus 100 and the wirelessly chargeable devices 200, and wireless power is transmitted through the resonance channel.

The wireless power supply apparatus 100 may receive information on the wirelessly chargeable devices 200_1, 200_2, . . . , and 200_N including identification (ID) information, types, locations, or charging states thereof through wireless communication with the wirelessly chargeable devices 200_1, 200_2, . . . , and 200_N, and may transmit power to the wirelessly chargeable devices 200_1, 200_2, . . . , and 200_N based on this charging information.

In a method for wireless communication between the wireless power supply apparatus 100 and the wirelessly chargeable devices 200, magnetic field communication using a magnetic field communication protocol may be used.

The wireless power supply apparatus 100 may be implemented in a fixed type or a mobile type. When the wireless power supply apparatus 100 is implemented in the fixed type, the wireless power supply apparatus 100 may be installed indoors on a ceiling, furniture, such as a table, etc., and may be installed outdoors at a bus stop, in a subway station. The wireless power supply apparatus 100 may also be installed in mobile objects, such as a vehicle, a train, or a subway car. When the wireless power supply apparatus 100 is implemented in the mobile type, the wireless power supply apparatus 100 may be implemented as a separate mobile apparatus, or implemented as a part of another digital device such as a cover of a laptop computer.

The wirelessly chargeable devices 200_1, 200_2, . . . , and 200_N may include all digital devices having a battery, such as various types of mobile terminals, digital cameras, and laptop computers, and may be electronic devices, such as sensors and measuring instruments, disposed in places which are not easy to access, such as underground, underwater, and inside a building.

When the wireless power supply apparatus 100 intends to charge the plurality of wirelessly chargeable devices 200_1, 200_2, . . . , and 200_N in the multi-node wireless charging system based on wireless communication, if the plurality of wirelessly chargeable devices 200_1, 200_2, . . . , and 200_N move actively, a communication area is generally larger than a power transmission area.

Therefore, the wirelessly chargeable devices 200_1, 200_2, . . . , and 200_N may register themselves with the wireless power supply apparatus 100 in the communication area, and the wireless power supply apparatus 100 may transmit power to reflect power transmission requests from the registered wirelessly chargeable devices 200_1, 200_2, . . . , and 200_N.

Also, in order to monitor whether or not there is a newly added wirelessly chargeable device, the wireless power supply apparatus 100 may send an association request periodically or intermittently.

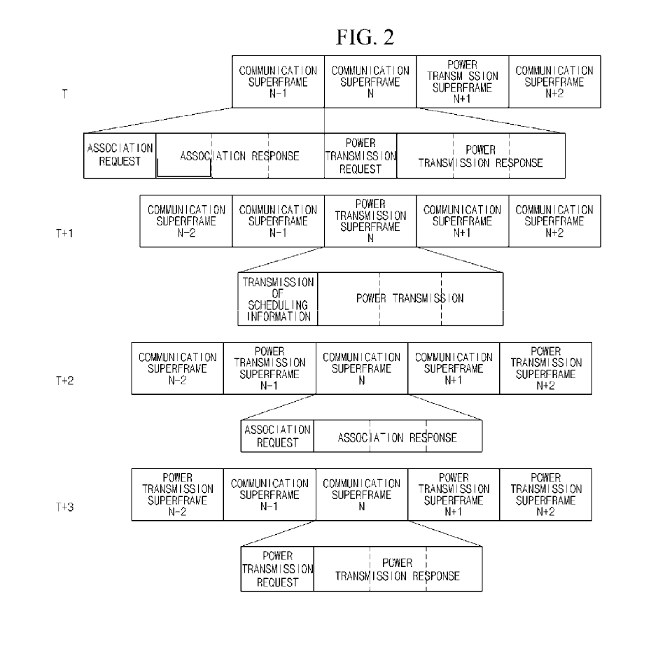

FIG. 2 shows a structure of a superframe used for communication and charging in a multi-node wireless charging system according to an embodiment of the present invention.

As shown in FIG. 2, when power is transmitted to a plurality of wirelessly chargeable devices in a multi-node wireless charging system based on wireless communication, a wireless power supply apparatus first transmits an association request to wirelessly chargeable devices in a communication area (T: an association request period of a communication superframe N−1), and the wirelessly chargeable devices in the communication area transmit their unique IDs to the wireless power supply apparatus through association responses (T: an association response period of a communication superframe N−1).

Since a wireless charging system according to an embodiment of the present invention is a multi-node wireless charging system capable of charging a plurality of wirelessly chargeable devices, each wirelessly chargeable device transmits its response in the corresponding slot.

When the association responses are received, the wireless power supply apparatus assigns dynamic IDs corresponding to the unique IDs of the wirelessly chargeable devices, and transmits a power transmission request based on the assigned dynamic IDs so as to find a wirelessly chargeable device which desires power transmission (T: a power transmission request period of the communication superframe N). Wirelessly chargeable devices which need to receive power send their battery information, the amount of power desired to be received per hour, etc. to the wireless power supply apparatus through power transmission responses (T: a power transmission response period of the communication superframe N).

Upon receiving the power transmission responses of the wirelessly chargeable devices, the wireless power supply apparatus performs time-division scheduling for power transmission and makes a schedule for the wirelessly chargeable devices which simultaneously receive power, according to the responses. Also, the wireless power supply apparatus sends the slot time length of a power transmission period and information on the wirelessly chargeable devices which will receive power by transmitting scheduling information (T+1: a scheduling information transmission period of a power transmission superframe N). In the power transmission period, the corresponding wirelessly chargeable devices receive power, and states in the power transmission period are monitored in real time by measuring currents and voltages of the wirelessly chargeable devices. After the power transmission superframe, an association request may be sent so as to determine whether or not a new wirelessly chargeable device has entered a communication area (T+2: an association request period of the communication superframe N), or a wirelessly chargeable device which newly desires power transmission may be found through a power transmission request (T+3: a power transmission request period of the communication superframe N).

As described above, a state in the power transmission period is monitored in real time by measuring a current and a voltage of a wirelessly chargeable device. Accordingly, when a change of a power transmission environment is sensed, it is possible to perform re-matching or rescheduling and transmit new scheduling information in a new superframe.

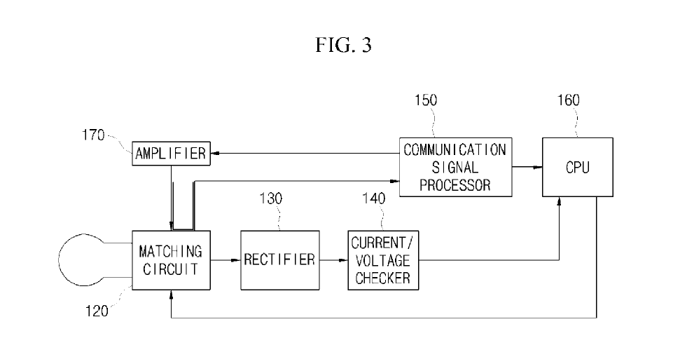

FIG. 3 is a diagram showing in detail a constitution of a wireless power supply apparatus of a multi-node wireless charging system according to an embodiment of the present invention.

As shown in FIG. 3, a wireless power supply apparatus 100 of a multi-node wireless charging system according to an embodiment of the present invention includes a transmitting antenna 110, a matching circuit 120 connected to the transmitting antenna 110, a rectifier 130 which converts an alternating current (AC) voltage applied through the matching circuit 120 into a direct current (DC) voltage, and a current/voltage checker 140 which is connected to the rectifier 130 and may check a change of a current and/or the voltage.

The matching circuit 120 may be connected to a communication signal processor 150 to process a communication signal with a wirelessly chargeable device, and the communication signal processor 150 is connected to an amplifier 170 for amplifying a transmission signal.

The wireless power supply apparatus 100 includes a central processing unit (CPU) 160 connected with the matching circuit 120, the current/voltage checker 140, and the communication signal processor 150, so that multi-node wireless power transmission based on wireless communication is processed by the CPU 160.

Meanwhile, although not shown in FIG. 3, the wireless power supply apparatus 100 may further include an oscillator connected to the amplifier 170.

The current/voltage checker 140 senses an environmental change in a power transmission period through a change of the current and/or the voltage, and makes it possible to maintain an optimal power transmission environment accordingly.

For example, when a change of the current and/or the voltage is sensed while power transmission is performed in a power transmission superframe, it is possible to determine that there has been an environmental change, such as the entry of a new wirelessly chargeable device or the completion of charging of a wirelessly chargeable device which is being charged. In this case, the wireless power supply apparatus 100 may send an association request through a communication superframe, or find a wirelessly chargeable device which newly desires power transmission through a power transmission request and transmit new scheduling information including the found wirelessly chargeable device.

On the other hand, when no change of the current and/or the voltage is sensed while power transmission is performed in a power transmission superframe, it is unnecessary to newly send an association request or a power transmission request, and continuous charging may be performed by connecting a power transmission superframe to the power transmission superframe (T+3 of FIG. 2: a power transmission superframe N+1, a power transmission superframe N+2).

Meanwhile, in the structure of a superframe shown in FIG. 2, the length of each period and slot may be variable.

In a multi-node wireless charging system according to an embodiment of the present invention, a magnetic field area network (MFAN) may be used as a wireless communication method.

An MFAN is a wireless network for transmitting and receiving information using a magnetic field signal in a low frequency band (30 KHz to 300 KHz). The center frequency of wireless communication is 128 KHz, and binary phase shift keying (BPSK) or amplitude shift keying (ASK) is used as a modulation method. Manchester coding and non-return-to-zero level (NRZ-L) coding are used to diversify data rates, so that data rates of several kbps are provided at a distance of several meters. Devices participating in an MFAN are classified as an MFAN-coordinator (C) and an MFAN-node (N) according to their roles. In one MFAN, there is only one MFAN-C, and a plurality of MFAN-Ns form the network based on the MFAN-C. The MFAN-C manages association, separation, and release of MFAN-Ns.

In a multi-node wireless charging system according to an embodiment of the present invention, the wireless power supply apparatus 100 serves as a coordinator, and the wirelessly chargeable devices 200 serve as nodes.

However, communication between a wireless power supply apparatus and a wirelessly chargeable device is not necessarily limited to magnetic field communication, and another communication method equivalent or similar thereto may be used.

In a multi-node wireless charging system according to an embodiment of the present invention, wireless charging may be performed using a magnetic resonance method or a magnetic induction method.

When wireless charging is performed using the magnetic resonance method, a wireless power supply apparatus and a wirelessly chargeable device form a resonance channel by matching a resonant frequency, and transmit wireless power through the resonance channel.

According to an embodiment of the present invention, when there is a change of distances from wirelessly chargeable devices which receive power or a change of the number of wirelessly chargeable devices, a current/voltage change is sensed using a current/voltage checker to sense a change of a power transmission environment, and a matching circuit is controlled or power transmission is rescheduled according to the change. In this way, it is possible to maintain an optimal power transmission environment and actively cope with a variable power transmission environment.

Also, in a multi-node wireless charging system according to an embodiment of the present invention, one or more devices may receive wireless power during each time slot. In this case, the one or more wirelessly chargeable devices which are charging targets form a resonance channel by matching a resonant frequency with a wireless power supply apparatus. In other words, in an embodiment of the present invention, a power transmission method based on time division and a simultaneous power transmission method based on multi-matching are used in combination to simultaneously charge a plurality of devices.

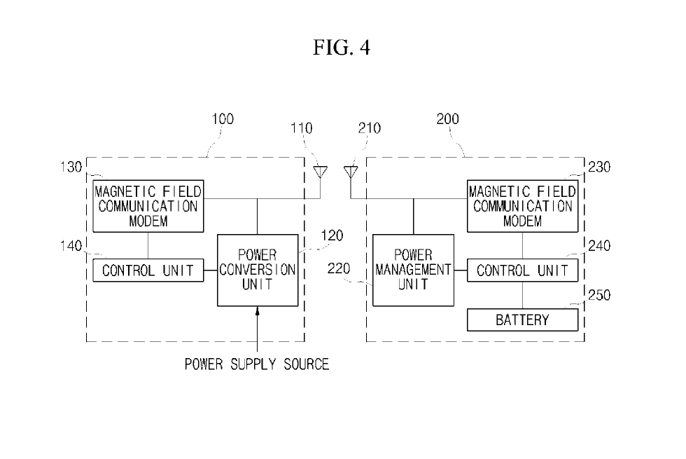

FIG. 4 is a block diagram showing constitutions of a wireless power supply apparatus and a wirelessly chargeable device in a multi-node wireless charging system according to another embodiment of the present invention.

As shown in FIG. 4, a wireless power supply apparatus 100 of a multi-node wireless charging system according to the other embodiment of the present invention includes a power conversion unit 120 which is supplied with power from an external power supply source and converts the power into AC power having a resonant frequency band between the wireless power supply apparatus 100 and a wirelessly chargeable device 200, a magnetic field communication modem 130 which enables magnetic field communication with the wirelessly chargeable device 200 using a magnetic field communication protocol, a transmitting antenna 110 which transmits the AC power of the power conversion unit 120 and data of the magnetic field communication modem 130 to the wirelessly chargeable device 200, and a control unit 140 which controls components of the wireless power supply apparatus 100 including the power conversion unit 120 and the magnetic field communication modem 130.

The wirelessly chargeable device 200 of the multi-node wireless charging system according to the other embodiment of the present invention includes a receiving antenna 210 which wirelessly receives the power and the data from the wireless power supply apparatus 100, a magnetic field communication modem 230 which enables magnetic field communication with the wireless power supply apparatus 100 using the magnetic field communication protocol, a power management unit 220 which manages reception of the power, a control unit 240 which controls components of the wirelessly chargeable device 200 including the power management unit 220 and the magnetic field communication modem 230, and a battery 250 which is charged using the received power.

As a method of wirelessly transmitting power to a plurality of wirelessly chargeable devices in a multi-node wireless charging system using a single channel, there are a power transmission method based on time division and a simultaneous power transmission method based on multi-matching. In the time-division power transmission method, a plurality of wirelessly chargeable devices share wireless power resources through time scheduling, and in the simultaneous power transmission method, power is simultaneously transmitted to several wirelessly chargeable devices through active matching adjustment.

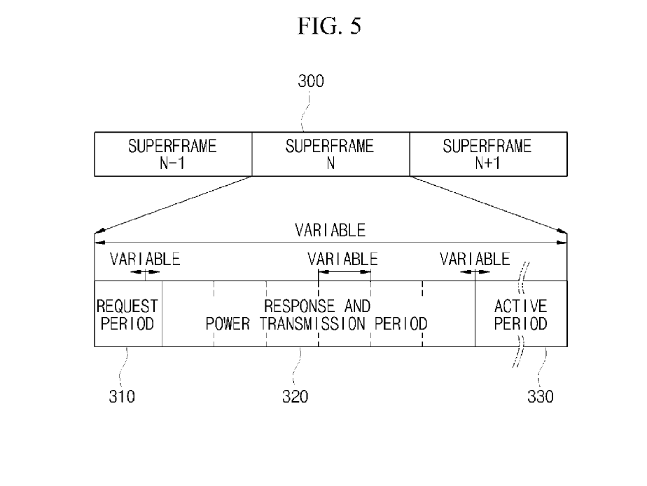

FIG. 5 is a diagram showing a structure of a superframe used in a multi-node wireless charging system according to an embodiment of the present invention.

In a multi-node wireless charging system using a single channel based on magnetic field communication, data is exchanged through time division, and power transmission is performed based on time division. To this end, a repeated superframe structure as shown in FIG. 5 is used.

As shown in FIG. 5, one superframe 300 includes a request period 310, a response and power transmission period 320, and an active period 330, and the lengths of the respective periods 310, 320, and 330 are variable. In the request period 310, a wireless power supply apparatus may send an association request, a power-reception request, or power transmission scheduling information to the wirelessly chargeable device, and in the response period 320, the wirelessly chargeable device may send an association response or power-reception response information at a request of the wireless power supply apparatus. In the power transmission period 320, the wireless power supply apparatus may transmit power to the wirelessly chargeable device, and in the active period 330, the wireless power supply apparatus or the wirelessly chargeable device may randomly transmit data.

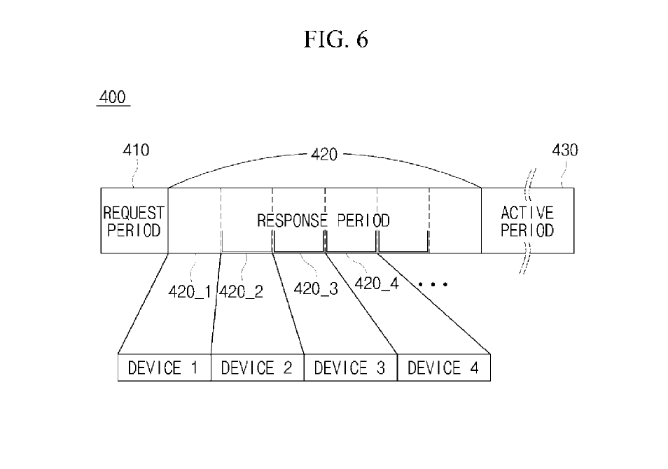

FIG. 6 is a diagram showing a response period of a superframe according to another embodiment of the present invention.

As shown in FIG. 6, a superframe 400 is started when a wireless power supply apparatus transmits a response request packet in a request period 410. The response request packet has information on devices capable of transmitting response packets in a response period 420, and the devices transmit the response packets using the information in the response request packet during the response period 420. In other words, a plurality of wirelessly chargeable devices (device 1 to device 4) in a wireless power transmission system receive a response request packet, and then transmit response packets during slots 420-1, 420-2, 420-3, and 420-4 assigned thereto in the response period 420.

In a multi-node wireless charging system according to an embodiment of the present invention, one or more wirelessly chargeable devices may receive wireless power during each time slot. To this end, one or more devices that are charging targets, that is, wirelessly chargeable devices, form a resonance channel by matching a resonant frequency with a wireless power transmission apparatus. In other words, a multi-node wireless charging system according to an embodiment of the present invention can use time-division power transmission and simultaneous power transmission in combination.

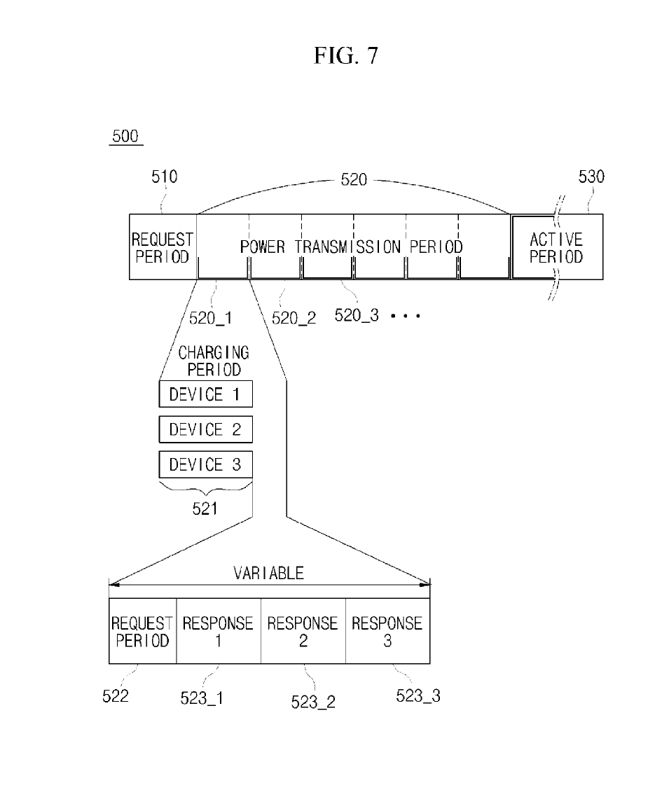

FIG. 7 shows a structure of a superframe to this end, that is, a detailed structure of each time slot constituting a power transmission period 520.

When a wireless power supply apparatus transmits a scheduling result shown in FIG. 7 according to responses of respective devices to the respective wirelessly chargeable devices through a request period 510 shown in FIG. 7, the wirelessly chargeable devices corresponding to the power transmission period 520 receive power. During a slot time determined upon scheduling, one or more wirelessly chargeable devices may receive power. At this time, wirelessly chargeable devices other than the corresponding wirelessly chargeable devices open antennas so as not to influence matching, and connect to the antennas so as to check request information of the wireless power supply apparatus after power transmission of the corresponding slot.

FIG. 7 shows a case in which three wirelessly chargeable devices (device 1 to device 3) are scheduled to receive power in a first slot 520_1 of the power transmission period 520.

When one or more wirelessly chargeable devices receive power in one slot, the wireless power supply apparatus transmits wireless power to the one or more wirelessly chargeable devices (device 1 to device 3) which are targets during a charging period 521 as shown in FIG. 7. When the wireless power supply apparatus sends a power receiving state request 522 together with response sequence information after the wireless power transmission ends, the corresponding wirelessly chargeable devices send power receiving state acknowledgements (ACKs) 523_1, 523_2, and 523_3 in sequence. However, at this time, the wireless power supply apparatus may not request responses from the wirelessly chargeable devices which have received the power.

The power receiving state request packet 522 is shorter and simpler than request packets transmitted by wireless power supply apparatuses in the request periods 310, 410, and 510, and the power receiving state ACKs also are configured to be short and simple. The lengths of the ACK packets may be fixed, or the ACK packets may not be transmitted as mentioned above.

In a power receiving state request period 522, all wirelessly chargeable devices including the wirelessly chargeable devices, which are charging targets of the corresponding power transmission slot 520_1, and included in a wireless power transmission system wake up and receive the power receiving state request packet.

When the wireless power supply apparatus is infiltrated by a foreign substance or an error occurs, the wireless power supply apparatus may indicate this through the request period, and during the request period, all the wirelessly chargeable devices included in the multi-node wireless power transmission system may wake up and receive the power receiving state request.

When it is necessary to start a superframe again due to the infiltration of a foreign substance or the occurrence of an error, the wireless power supply apparatus indicates the infiltration of a foreign substance or the occurrence of an error using a power receiving state request packet, and thus each wirelessly chargeable device can determine whether or not power transmission will be continuously performed in a next slot. Wirelessly chargeable devices which will receive power during the next slot receive the power receiving state request information and prepare the next slot.

Preferred embodiments for exemplifying the technical spirit of the present invention have been described and shown above, but the present invention is not limited to the shown and described constitutions and effects. Those of ordinary skill in the art would appreciate that various changes and modifications of the present invention can be made without departing from the technical spirit. Therefore, it is to be understood that all suitable changes, modifications, and equivalents fall within the scope of the present invention.

1. A multi-node wireless charging method for a wireless power supply apparatus to charge a plurality of wirelessly chargeable devices in a multi-node wireless power transmission system including the wireless power supply apparatus and the wirelessly chargeable devices spaced apart from the wireless power supply apparatus and wirelessly communicating with the wireless power supply apparatus, the multi-node wireless charging method comprising:
transmitting an association request frame;
receiving association response frames from the wirelessly chargeable devices;
transmitting a power transmission request frame;
receiving charging request response frames from the wirelessly chargeable devices;
transmitting wireless-charging schedule information for the wirelessly chargeable devices having transmitted the charging request response frames; and
transmitting power to the wirelessly chargeable devices according to the wireless-charging schedule information,
wherein the transmitting of the power comprises monitoring a change of a power transmission environment by measuring a voltage or a current of the wireless power supply apparatus.

2. The multi-node wireless charging method of claim 1, wherein the transmitting of the association request frame, the receiving of the association response frames, the transmitting of the power transmission request frame, the receiving of the charging request response frames, and the transmitting of the wireless-charging schedule information are periodically repeated.

3. The multi-node wireless charging method of claim 1, wherein, when the change of the power transmission environment is sensed, the transmitting of the association request frame, the receiving of the association response frames, the transmitting of the power transmission request frame, the receiving of the charging request response frames, and the transmitting of the wireless-charging schedule information are performed again.

4. The multi-node wireless charging method of claim 1, wherein, when the change of the power transmission environment is sensed, the wireless power supply apparatus controls a matching circuit in the wireless power supply apparatus to perform frequency matching.

5. The multi-node wireless charging method of claim 1, wherein the association response frame includes unique identifications (IDs) of the wirelessly chargeable devices.

6. The multi-node wireless charging method of claim 5, further comprising assigning dynamic IDs corresponding to the unique IDs of the wirelessly chargeable devices.

7. The multi-node wireless charging method of claim 6, wherein the power transmission request frame is transmitted based on the dynamic IDs.

8. The multi-node wireless charging method of claim 1, wherein the charging request response frames include battery information of the wirelessly chargeable devices and information on amounts of power desired to be received per hour.

9. The multi-node wireless charging method of claim 1, wherein the transmitting of the power comprises simultaneously transmitting the power to two or more of the wirelessly chargeable devices.

10. A wireless power supply apparatus wirelessly communicating with a plurality of wirelessly chargeable devices and supplying wireless power to the plurality of wirelessly chargeable devices, the wireless power supply apparatus comprising:
an oscillator configured to generate a signal of a predetermined uniform frequency;
an amplifier configured to amplify the signal generated by the oscillator;
a matching circuit configured to frequency match the signal amplified by the amplifier;
a transmitting antenna configured to transmit the signal frequency-matched by the matching circuit to the wirelessly chargeable devices;
a rectifier configured to convert an alternating current (AC) voltage applied through the matching circuit into a direct current (DC) voltage;
a current/voltage checker connected to the rectifier and configured to check a change of a current and/or the voltage; and
a communication signal processor connected to the matching circuit and configured to process a communication signal with the wirelessly chargeable devices.

11. A multi-node wireless charging method for a wireless power supply apparatus to charge a plurality of wirelessly chargeable devices in a multi-node wireless power transmission system including the wireless power supply apparatus and the wirelessly chargeable devices spaced apart from the wireless power supply apparatus and wirelessly communicating with the wireless power supply apparatus, the multi-node wireless charging method comprising:
transmitting wireless power to the wirelessly chargeable devices during a power transmission period divided into two or more slots so as to transmit the wireless power using a time-division method,
wherein the wireless power is simultaneously transmitted to two or more of the wirelessly chargeable devices in one of the slots.

12. The multi-node wireless charging method of claim 11, wherein the slots include:
a charging period for simultaneously transmitting the wireless power to the two or more wirelessly chargeable devices; and
a request period in which the wireless power supply apparatus transmits a power receiving state request to the wirelessly chargeable devices.

13. The multi-node wireless charging method of claim 12, wherein the slots further include, after the request period, two or more response periods for sequentially receiving response packets from the two or more wirelessly chargeable devices.

14. The multi-node wireless charging method of claim 13, wherein lengths of the response periods are fixed.

15. The multi-node wireless charging method of claim 12, wherein a length of the charging period is variable.

16. The multi-node wireless charging method of claim 12, wherein a length of the request period is variable.

17. The multi-node wireless charging method of claim 12, wherein, when the wireless power supply apparatus is infiltrated by a foreign substance or an error occurs, the wireless power supply apparatus indicates the infiltration of the foreign substance or the occurrence of the error through the request period.

18. The multi-node wireless charging method of claim 12, wherein, during the request period, all the wirelessly chargeable devices included in the multi-node wireless power transmission system wake up and receive the power receiving state request.

19. The multi-node wireless charging method of claim 11, further comprising, before the transmitting of the wireless power, transmitting wireless-charging schedule information for the wirelessly chargeable devices to the wirelessly chargeable devices.
